(19) United States
(12) Patent Application Publication
(10) Pub. No.: US 2018/0039017 A1
(43) Pub. Date: Feb. 8, 2018

(54) LIGHT GUIDE PLATE, RELATED DISPLAY DEVICE, AND RELATED MANUFACTURING METHOD

(71) Applicant: Samsung Display Co., Ltd., Yongin-si (KR)

(72) Inventors: Jung Suk BANG, Yongin-si (KR); Min Jeong OH, Yongin-si (KR); Kwang Soo BAE, Yongin-si (KR); Hae Ju YUN, Yongin-si (KR)

(21) Appl. No.: 15/665,795

(22) Filed: Aug. 1, 2017

(30) Foreign Application Priority Data
Aug. 8, 2016 (KR) 10-2016-0100875

(51) Int. Cl. F21V 8/00

(52) U.S. Cl. CPC G02B 6/0088; G02B 6/0055; G02B 6/0065; G02B 6/0083

(57) ABSTRACT

A light guide plate may include a substrate, a plurality of light blockers, a first light guide layer, and a second light guide layer. The light blockers may be positioned on the substrate and may include a first light blocker. The first light guide layer may be positioned on the substrate, may include base portions, and may include protrusions. The protrusions may protrude from the base portions and may include a first protrusion. The first light blocker may be positioned between the substrate and the first protrusion and may be positioned between two of the base portions. The second light guide layer may be positioned on the first light guide layer. Portions of the second light guide layers may overlap the base portion s and may be positioned between the protrusions.

### CROSS-REFERENCE TO RELATED APPLICATION

This application claims priority to and the benefit of Korean Patent Application No. 10-2016-0100875, filed on Aug. 8, 2016, in the Korean Intellectual Property Office; the entire contents of the Korean Patent Application are incorporated herein by reference in their entirety.

### BACKGROUND

### 1. Field

The technical field relates to a light guide plate (or “light plate” for conciseness), a display device including the light guide plate, and a method of manufacturing the light guide plate.

### 2. Description of the Related Art

A display device, such as a liquid crystal display device, may include a display panel and may include a backlight unit for supplying light to the display panel.

The backlight unit generally includes a light source for providing light, a circuit board for supplying power to the light source, and optical members. The optical members may include a waveguide member, a light collecting member, a diffusion member, and a polarizing member for substantially uniformly supplying the light to the display panel.

### SUMMARY

An embodiment may be related to a display device. The display device may include the following elements: a display panel; a light source configured to supply light; and a light plate positioned on a rear surface of the display panel and configured to guide the light to the display panel, in which the light plate includes: a substrate; a first light guide layer formed on the substrate and protruding in a first direction; and a second light guide layer configured to cover the first light guide layer.

The display device may further include a light blocking pattern formed on the substrate, in which the substrate may have an emissive region and a non-emissive region, and the light blocking pattern may be formed in the non-emissive region.

The first light guide layer may include: a first sub light guide layer formed in the emissive region; a second sub light guide layer formed so as to face the light blocking pattern; and an inclined portion, which connects the first sub light guide layer and the second sub light guide layer, and is inclined so as to have a predetermined angle with respect to one surface of the substrate.

The light may be redirected toward the display panel on an interface of the inclined portion and the second light guide layer.

The second sub light guide layer may include a plurality of holes.

A region surrounded by the light blocking pattern, the inclined portion, and the second sub light guide layer may be empty.

The first light guide layer may have patterns having truncated shapes, of which inner sides are hollow.

The first light guide layer may include a first material, and the second light guide layer may include a second material different from the first material.

An embodiment may be related to a method of manufacturing a light plate (or light guide plate) which may guide incident light to be emitted through an emissive region. The method may include the following steps: forming a light blocking pattern in a non-emissive region of a substrate; forming a first light guide layer, which protrudes in a first direction, on the substrate; and forming a second light guide layer on the first light guide layer.

The forming of the light blocking pattern may include: forming a light blocking layer on the substrate; forming a sacrificial layer on the light blocking layer; and etching the light blocking layer by using the sacrificial layer as a mask, and the sacrificial layer may be formed in the non-emissive region of the substrate.

The sacrificial layer may include patterns having tapered shapes.

The first light guide layer may be formed so as to cover the substrate and the sacrificial layer.

The method may further include: before the forming of the second light guide layer, forming a photosensitive film pattern for forming holes for removing the sacrificial layer on the first light guide layer; and forming the holes by an etching process using the photosensitive film pattern as a mask.

The method may further include: removing the photosensitive film pattern; and removing the sacrificial layer.

The first light guide layer may include a first material, and the second light guide layer may include a second material different from the first material.

An embodiment may be related to a light plate (or light guide plate). The light plate may include the following elements: a substrate having an emissive region and a non-emissive region and configured to guide light; a light blocking pattern formed on the non-emissive region of the substrate; a first light guide layer formed on the substrate and protruding in a first direction in the non-emissive region; and a second light guide layer formed on the first light guide layer.

The first light guide layer may include: a first sub light guide layer formed in the emissive region; a second sub light guide layer formed so as to face the light blocking pattern; and an inclined portion, which connects the first sub light guide layer and the second sub light guide layer, and is inclined so as to have a predetermined angle with respect to one surface of the substrate.

A region surrounded by the first sub light guide layer and the inclined portion connected to the first sub light guide layer may have a truncated shape, of which an inner side is hollow.

A region surrounded by the light blocking pattern, the inclined portion, and the second sub light guide layer may be empty.

A refractive indexes of the first light guide layer may be unequal to a refractive index of the second light guide layer.

An embodiment may be related to a display device. The display device may include: the following elements: a display panel; a light source for supplying light; a substrate, which overlap the display panel and may receive the light from the light source; a first light guide layer, which is positioned between the substrate and the display panel, may receive the light from the substrate, and may include base portions and protrusions, wherein the protrusions protrude from the base portions toward the display panel; and a second light guide layer, which may receive the light from the first light guide layer and may provide the light toward the display panel, wherein portions of the second light guide layer may overlap the base portions and may be positioned between the protrusions.

The display device may include light blockers positioned between the substrate and the protrusions, respectively, and positioned between the base portions.

The light blockers may include a first light blocker. The protrusions may include a first protrusion. The base portions may include a first base portion. The first protrusion may include a first overlapping portion and a first inclined portion. The first overlapping portion may overlap the first light blocker, may be positioned between the first light blocker and the display panel, and may be connected through the first inclined portion to the first base portion. The first inclined portion may be directly connected to each of the first base portion and the first overlapping portion and may be oriented at a predetermined acute angle with respect to a surface of the substrate.

The first inclined portion may receive the light from the first base portion and may reflect the light. A portion of the second light guide layer may directly contact the first inclined portion, may receive the light from the first inclined portion, and may transmit the light toward the display panel.

The first overlapping portion may include a through hole.

The first protrusion may have a cavity that is surrounded by the first light blocker, the first inclined portion, and the first overlapping portion.

The protrusions may be hollow.

The first light guide layer may include and/or may be formed of a first material. The second light guide layer may include and/or may be formed of a second material different from the first material.

An embodiment may be related to a method for manufacturing a light guide plate. The method may include the following steps: forming a plurality of light blockers on a substrate, wherein light blockers include a first light blocker; forming a first light guide layer on the substrate, wherein the first light guide layer may include base portions and protrusions, wherein the protrusions may protrude from the base portions and may include a first protrusion, and wherein the first light blocker may be positioned between the substrate and the first protrusion and may be positioned between two of the base portions; and forming a second light guide layer on the first light guide layer, wherein portions of the second light guide layers overlap the base portion s and may be positioned between the protrusions.

The forming of the light blockers may include the following steps: forming a light blocking layer on the substrate; forming a sacrificial member set on the light blocking layer; and etching the light blocking layer using the sacrificial member set as a mask.

The sacrificial member set may include tapered sacrificial members.

The first light guide layer may directly contact each of the substrate and the sacrificial member set.

The method may include the following steps before the forming of the second light guide layer: forming holes at the protrusions; and removing the sacrificial member set through the holes.

The method may include covering the holes using parts of the second light guide layer.

The first light guide layer may include and/or may be formed of a first material. The second light guide layer may include and/or may be formed of a second material different from the first material.

An embodiment may be related to a light guide plate. The light guide plate may include a substrate, a plurality of light blockers, a first light guide layer, and a second light guide layer. The light blockers may be positioned on the substrate and may include a first light blocker. The first light guide layer may be positioned on the substrate, may include base portions, and may include protrusions. The protrusions may protrude from the base portions and may include a first protrusion. The first light blocker may be positioned between the substrate and the first protrusion and may be positioned between two of the base portions. The second light guide layer may be positioned on the first light guide layer. Portions of the second light guide layers may overlap the base portion s and may be positioned between the protrusions.

The first protrusion may include a first overlapping portion and a first inclined portion. The first overlapping portion may overlap the first light blocker. The first inclined portion may be directly connected to a base portion of the first light guide layer, may be directly connected to the first overlapping portion, and may be oriented at a predetermined acute angle with respect to a surface of the substrate.

The first protrusion may have a cavity surrounded by the first inclined portion. The cavity has a first cavity portion and a second cavity portion. The second cavity portion may be positioned between the first cavity portion and the substrate and may be wider than the first cavity portion in a direction parallel to the surface of the substrate.

The first protrusion may have a through hole and a cavity. The through hole may be narrower than the cavity, may be positioned between the cavity and a part of the second light guide layer, may be directly connected to the cavity, and may be covered by the part of the second light guide layer.

A refractive index of the first light guide layer may be unequal to a refractive index of the second light guide layer.

According to embodiments, backlight emission efficiency may be optimized in a display device.

According to embodiments, a thickness of a backlight unit may be minimized. Advantageously, a thickness and a weight of a display device that includes the backlight unit may be minimized.

### BRIEF DESCRIPTION OF THE DRAWINGS

FIG. 1 is an exploded perspective view illustrating a display device according to an embodiment.

FIG. 2 is a cross-sectional view taken along line I-I′ of FIG. 1 according to an embodiment.

FIG. 3 is a cross-sectional view illustrating a light guide plate (or “light plate” for conciseness) illustrated in FIG. 2 according to an embodiment.

FIG. 4 is a diagram illustrating a route of light incident to the light plate illustrated in FIG. 3 according to an embodiment.

FIG. 5, FIG. 6, FIG. 7, FIG. 8, FIG. 9, FIG. 10, FIG. 11, and FIG. 12 are cross-sectional views illustrating structures formed in a method of manufacturing a light plate according to an embodiment.

### DETAILED DESCRIPTION

Example embodiments are described with reference to the drawings. Practical embodiments include all changes, equivalents, or alternatives to the described embodiments.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

In the drawings, in order to clearly express several layers and regions, scales of some elements may be exaggerated or reduced. Like reference numerals may indicate like elements In the description, a direction in which a user is positioned and/or an image is displayed may be described as an “upper direction” or a “front surface direction”, and an opposite direction may be described as a “lower direction” or a “rear surface direction” based on a display panel or display device.

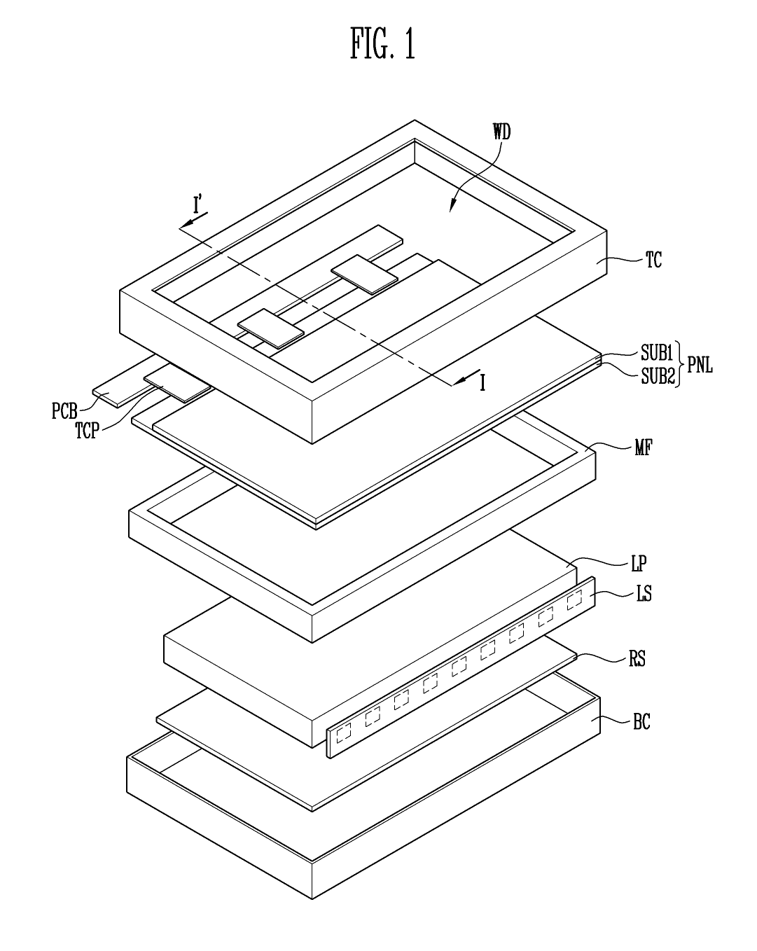

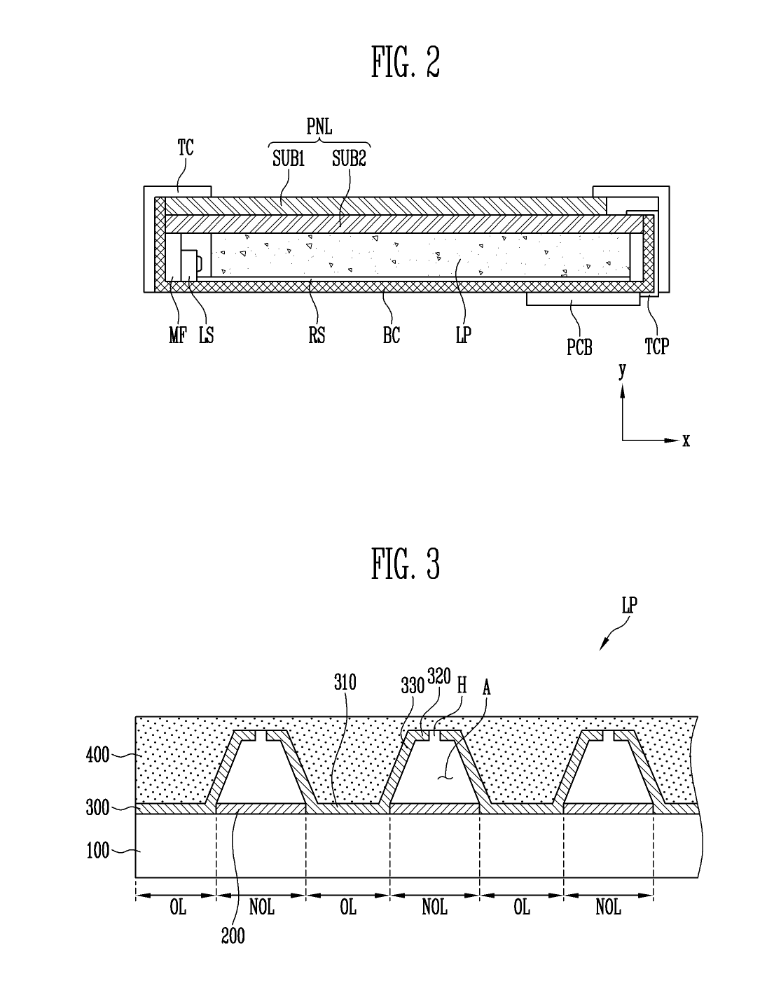

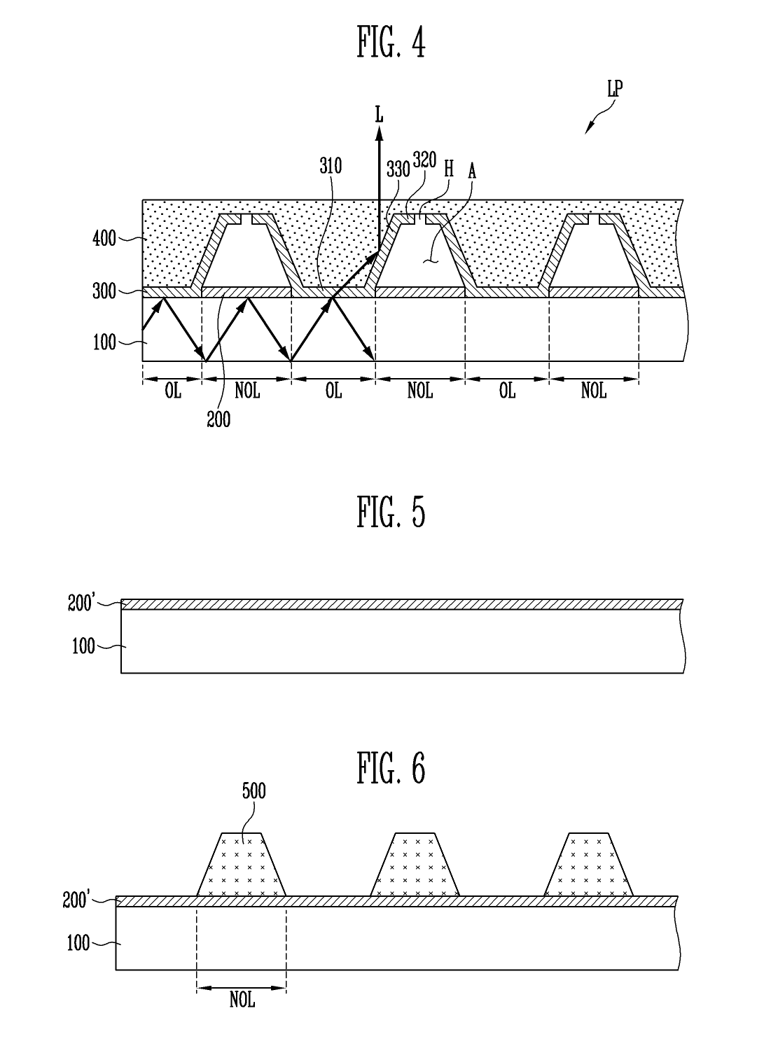

FIG. 1 is an exploded perspective view illustrating a display device (e.g., a liquid crystal display device) according to an embodiment, and FIG. 2 is a cross-sectional view taken along line I-I′ of FIG. 1 according to an embodiment.

Referring to FIGS. 1 and 2, the display device includes a display panel PNL and a backlight unit.

The display panel PNL may display an image.

The display panel PNL may be provided in a quadrangular plate shape having two pairs of parallel sides. For example, the display panel PNL may have a rectangular shape having a pair of long sides and a pair of short sides.

In an embodiment, the display panel PNL is a liquid crystal display panel. The display panel PNL may include a first substrate SUB1 and a second substrate SUB2 facing (and/or overlapping) the first substrate SUB1, and a liquid crystal layer (not illustrated) may be formed (and/or positioned) between the first substrate SUB1 and the second substrate SUB2.

According to the embodiment, the first substrate SUB1 may include a plurality of pixel electrodes (not illustrated) and a plurality of thin film transistors, which are electrically connected to the pixel electrodes while corresponding to the pixel electrodes one to one.

Each thin film transistor may switch a driving signal provided to the corresponding pixel electrode.

Further, the second substrate SUB2 may include a common electrode (not illustrated) forming an electric field, which controls an arrangement of the liquid crystals, together with the pixel electrodes. The display panel PNL may drive the liquid crystal layer and display an image in a front direction.

A tape carrier package TCP and a printed circuit board PCB, which is electrically connected with the display panel PNL through the tape carrier package TCP, may be provided on the display panel PNL. A driving circuit, such as a drive IC, may be mounted on the tape carrier package TCP.

The tape carrier package TCP may be attached to one side (e.g., a region not overlapping the second substrate SUB2) of the first substrate SUB1 in the display panel PNL.

For convenience of the description, FIG. 1 illustrates that the printed circuit board PCB and the display panel PNL are present on the same plane, but the printed circuit board PCB may be disposed on an external surface of a bottom chassis BC as illustrated in FIG. 2.

For example, the tape carrier package TCP may be bent along the external surface of the bottom chassis BC and connected to the display panel PNL and the printed circuit board PCB.

The backlight unit may provide light to the display panel PNL and may be positioned at a lower part (or back part) of the display panel PNL.

The backlight unit may include a mold frame MF supporting the display panel PNL, a light source LS for emitting light, a light plate LP (or light guide plate LP) for guiding the light toward the display panel PNL, a reflection sheet RS provided under the light plate LP, and the bottom chassis BC provided under the reflection sheet RS.

The mold frame MF is provided along a border of the display panel PNL and supports the display panel PNL in a lower side of the display panel PNL.

The mold frame MF may include a fixing member, for example, a latching law (not illustrated), for fixing or supporting other elements (for example, the light source LS), other than the display panel PNL.

The mold frame MF may be provided at positions corresponding to four sides of the display panel PNL, or at a position corresponding to at least a part of the four sides.

For example, the mold frame MF may have a quadrangular ring shape corresponding to the four sides of the display panel PNL, or may have a shape corresponding to three sides in the border of the display panel PNL.

The mold frame MF may be integrally formed, but the plurality of mold frames MF may be formed and assembled as necessary.

The mold frame MF may be formed of an organic material, such as a polymer resin. As long as the mold frame has the same shape and the same function, the mold frame may be formed of other materials.

Various light sources, such as a point light source, a line light source, or a surface light source, may be used as the light source LS.

In an embodiment, a plurality of light sources LS is provided under the display panel PNL.

In an embodiment, a single light source LS may be provided at one side of the display panel PNL.

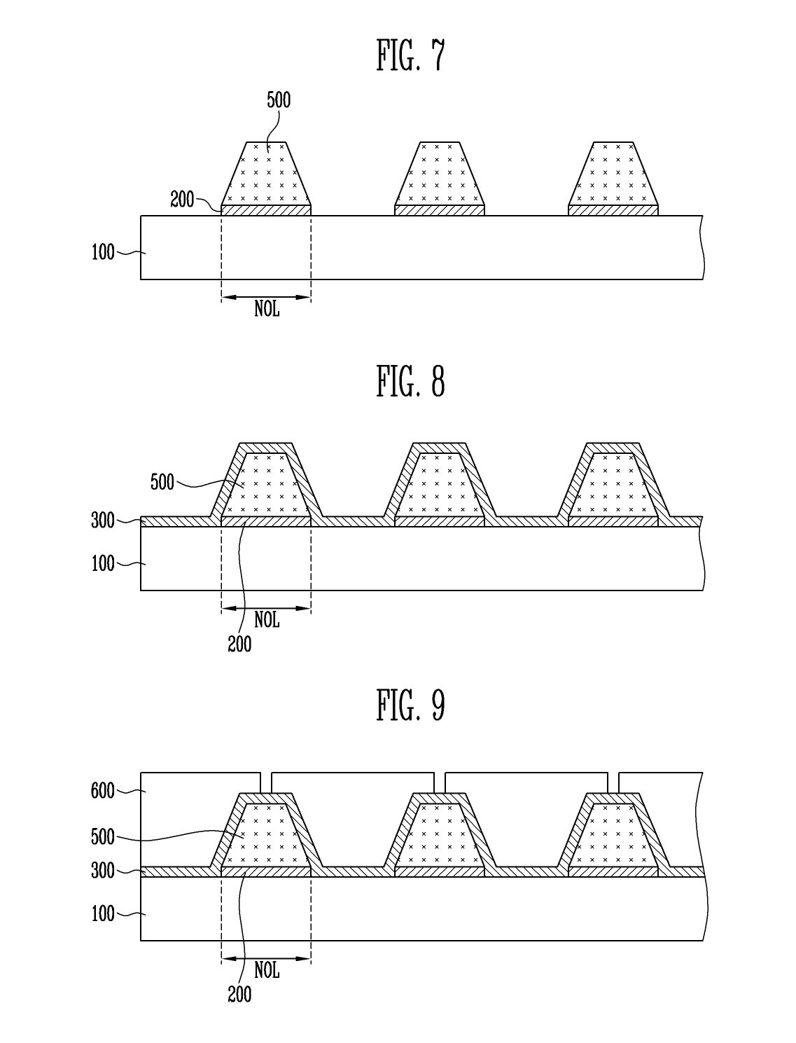

The light plate LP may guide the light emitted from the light source LS to the display panel PNL. The structure and the function of the light plate LP according to the embodiment will be described in detail with reference to FIG. 3.

The reflection sheet RS is positioned under the light plate LP, and reflects light, which is not provided in the direction of the display panel PNL and leaks, and changes a path of the light in the direction of the display panel PNL.

The bottom chassis BC is provided under the reflection sheet RS and accommodates the display panel PNL, the mold frame MF, the light source LS, the light plate LP, and the reflection sheet RS.

A top chassis TC may be provided on the display panel PNL. The top chassis TC may support a border of a front surface of the display panel PNL, and may cover a lateral surface of the mold frame MF or a lateral surface of the bottom chassis BC.

Although not illustrated in FIGS. 1 and 2, a polarizing plate may be provided on at least one surface of the display panel PNL.

A display window WD exposing a portion of the display panel PNL, on which an image is displayed, is formed in the top chassis TC.

In the meantime, the structure and the shape of the backlight unit are not limited to the illustration of FIGS. 1 and 2, and may be changed so as to have various structures and shapes.

Further, x-y coordinates illustrated in FIG. 2 may be equally applied to FIGS. 3 to 12.

FIG. 3 is a cross-sectional view illustrating the light plate LP illustrated in FIG. 2 according to an embodiment.

Referring to FIG. 3, the light plate LP may include a substrate 100, a light blocking pattern 200 (or light blocker set 200 including light blockers) formed (and/or positioned) on the substrate 100, a first light guide layer 300 formed (and/or positioned) on the substrate 100, and a second light guide layer 400 formed (and/or positioned) on the first light guide layer 300.

The substrate 100 may be a glass substrate having a light transmissive property. As long as the substrate 100 has the same shape and/or function, the substrate 100 may be formed of other materials.

The substrate 100 may have an emissive region OL and a non-emissive region NOL. The regions OL and NOL may depend on the positions of the light blockers of the light blocker set 200.

Light incident to the substrate 100 may be guided by total reflection and may be emitted from the substrate 100 through the emissive region OL.

The non-emissive region NOL may be blocked by the light blocker set 200 and may not emit light.

The light blocking pattern 200 is positioned on the substrate 100, and particularly, the light blocking pattern 200 is formed in the non-emissive region NOL and may block light refracted and/or reflected in the non-emissive region NOL from being emitted from the substrate 100.

The light blocking pattern 200 may include (and/or may be formed of) a metal, such as gold (Au), silver (Ag), aluminum (Al), molybdenum (Mo), chrome (Cr), tantalum (Ta), titanium (Ti), nickel (Ni), neodymium (Nd), copper (Cu), platinum (Pt), or an alloy.

The light blocking pattern 200 has a function of blocking light. In an embodiment, the light blocking pattern 200 may be formed of one or more other materials, such as one or more non-metal materials.

The first light guide layer 300 may be positioned on the substrate 100, and a part (i.e., a plurality of base portions) of the first guide layer 300 may directly contact the emissive region OL of the substrate 100, and a remainder (i.e., a plurality of protrusions) may protrude (from the base portions) in a first direction (y-axis direction) toward a display panel PNL when the light plate LP is included in a display device.

In an embodiment, the first guide layer 300 may include a first sub light guide layer 310 (or base portion set 310) and a plurality of protrusions. Each of the protrusions may include a second sub light guide layer 320 (or overlapping portion 320) and an inclined portion 330.

The first sub light guide layer 310 may be formed on the emissive region OL of the substrate 100.

A second sub light guide layer 320 (or overlapping portion 320) may face (or overlap) a corresponding light blocker of the light blocking pattern 200, and may be spaced apart from the corresponding light blocker by a predetermined interval. The second sub light guide layers 320 may correspond to the non-emissive region NOL.

An inclined portion 330 is directly connected to each of a corresponding base portion of the first sub light guide layer 310 and a corresponding second sub light guide layer 320 (or a corresponding overlapping portion 320). The inclined portion connects the base portion of the first sub light guide layer 310 to the second sub light guide layer 320.

In an embodiment, the inclined portion 330 may be inclined and/or oriented at a predetermined acute angle with respect to the substrate 100 (in a cross-sectional view of the light plate LP). In an embodiment, an angle between the light blocking pattern 200 and the inclined portion 330, which directly contacts the light blocking pattern 200, may be smaller than 90° (in a cross-sectional view of the light plate LP).

According to the embodiment, a cavity (or hollow space) surrounded by the first sub light guide layer 310 and an inclined portion 330 connected to the first sub light guide layer 310 may have a truncated circular cone shape. An inclined portion may have a truncated circular cone shape, with a trapezoid shape in a cross-sectional view of the first light guide layer 300, and with a circular shape in a plan view of the first light guide layer 300.

In an embodiment, the first light guide layer 300 may have truncated circular cone structures having hollow inner sides.

The first sub light guide layer 310, the second sub light guide layer 320, and the inclined portion 330 forming the first light guide layer 300 may be formed of the same material.

For example, the first light guide layer 300 may include an inorganic insulating layer formed of a silicon nitride SiNx or a silicon oxide SiOx.

Referring to FIG. 3, a region/cavity A surrounded by a light blocker of the light blocking pattern 200, an inclined portion 330, and a second sub light guide layer 320 may be empty. In an embodiment, the second sub light guide layer 320 may include a through hole for forming the region A.

The second light guide layer 400 may be formed on the first light guide layer 300.

One surface of the second light guide layer 400 may be flat, and the other surface of the second light guide layer 400 may have structures corresponding to structures of the first light guide layer 300. Portions of the second light guide layer 400 may overlap base portions of the first light guide layer 300 and may be positioned between protrusions of the first light guide layer 300.

The second light guide layer 400 may be formed of a different material from the material of the first light guide layer 300. For example, the second light guide layer 400 may include an organic layer, e.g., an organic insulating material. A fluorocarbon compound including at least one of polyacryl, polyimide, Teflon™, polyepoxy, and benzocyclobutene may be used as a material of the organic layer.

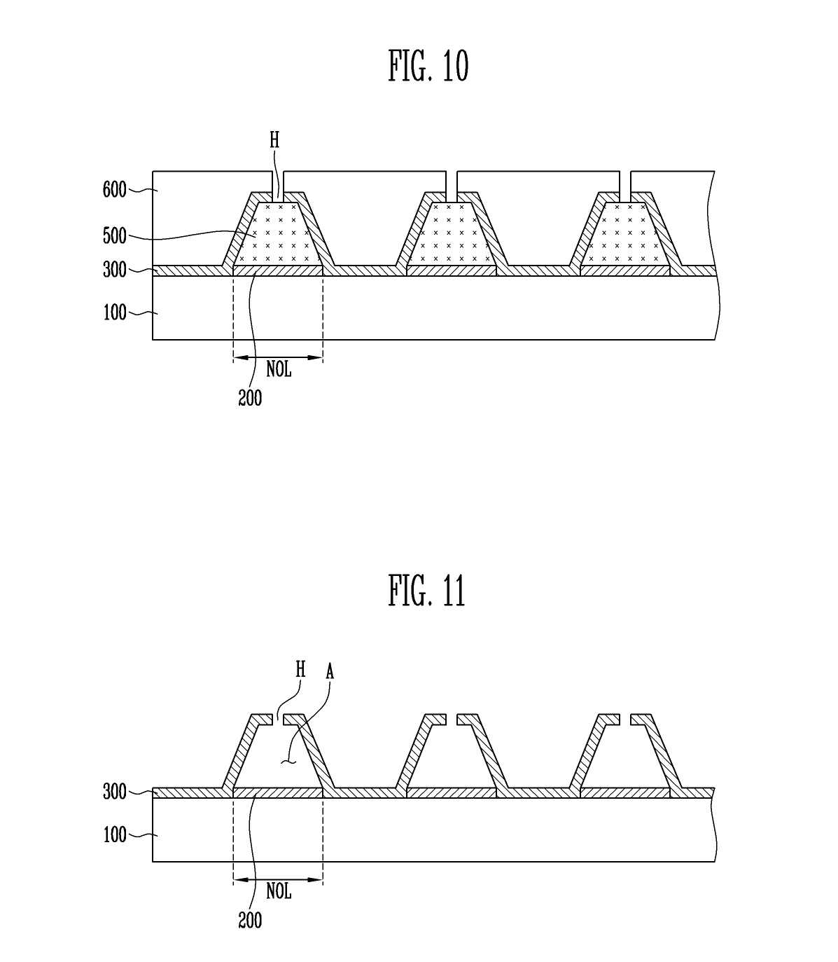

FIG. 4 is a diagram illustrating a path of light incident to the light plate illustrated in FIG. 3 according to an embodiment.

Referring to FIG. 4, light incident to the substrate 100 may be guided by total reflection, and a part of the incident light, or light L, may be reflected and move along the substrate 100. Another part of the incident light may pass through the substrate 100.

In an embodiment, the light blocking pattern 200 is positioned in the non-emissive region OL, so that the light L may pass through only the emissive region OL.

That is, the light blocking pattern 200 may prevent the light L from passing through the empty region/cavity A, so that light leakage may be prevented.

The light L passing through the substrate 100 may be refracted by a base portion of the layer 310 and/or may be reflected from an interface of the inclined portion 330 of the first light guide layer 300 and the second light guide layer 400, such that the light L may be provided in the first direction (i.e., y-direction or upward direction) toward a corresponding display panel PNL.

The up direction refers to a direction toward the display panel PNL to be provided on the light plate LP.

According to an embodiment, the refractive index of the substrate 100, the refractive index of the first light guide layer 300, and the refractive index of the second light guide layer 400 may be unequal to one another so that the light L may be provided in a desirable direction illustrated in FIG. 4.

According to an embodiment, the light L may be guided toward the display panel PNL without requiring an additional optical sheet. Accordingly, a thickness of the backlight unit may be minimized.

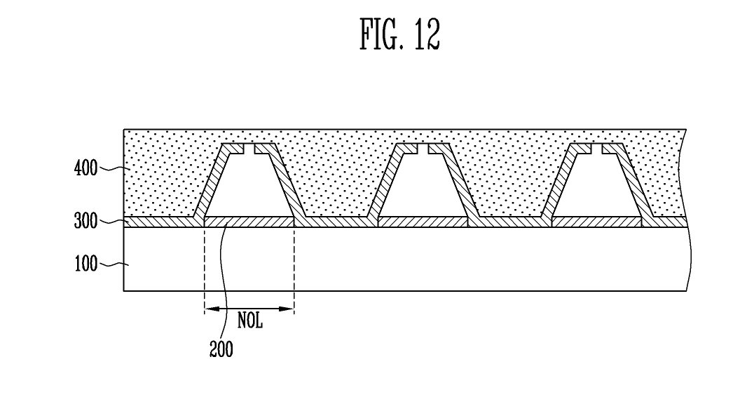

FIGS. 5 to 12 are cross-sectional views illustrating structures formed in a method of manufacturing the light plate according to an embodiment.

First, referring to FIG. 5, a light blocking layer 200′ for forming a light blocking pattern 200 is formed on a substrate 100. The light blocking layer 200′ may be formed by depositing or applying a metal material or an alloy.

Referring to FIG. 6, a sacrificial layer 500 (or sacrificial member set 500 including sacrificial members) is formed on the light blocking layer 200′, and the sacrificial layer 500 may be formed only in a predetermined non-emissive region NOL. The sacrificial layer 500 may be formed by applying a photoresist onto the light blocking layer 200′ and then performing a photolithography process.

In an embodiment, a cross-section of each sacrificial member of the sacrificial layer 500 may have a tapered shape (for example, a trapezoid shape) so that the first light guide layer, which is to be formed on the sacrificial layer 500, may have inclined portions.

Referring to FIG. 7, the light blocking layer 200′ is partially removed to form the light blocking pattern 200 only in the non-emissive region NOL. In an embodiment, an exposed region of the light blocking layer 200′ is etched and removed by an etching process using the sacrificial layer 500 as a mask.

Referring to FIG. 8, a first light guide layer 300 is formed on the substrate 100 and the sacrificial layer 500. The first light guide layer 300 may be formed by depositing or applying a first material. The first material may include an inorganic material formed of a silicon nitride (SiNx) or a silicon oxide (SiOx).

Referring to FIG. 9, a photosensitive film 600 is formed on the first light guide layer 300. The photosensitive film 600 may be formed by applying a photosensitive resin onto the first light guide layer 300 and performing a photolithography process. The photosensitive film 600 may have through holes positioned at protrusions of the first light guide layer 300.

Referring to FIG. 10, through holes H are formed in the first light guide layer 300. In an embodiment, an exposed region of the first light guide layer 300 is etched and removed by an etching process using the photosensitive film 600 as a mask.

Referring to FIG. 11, the photosensitive film 600 may be removed, and the sacrificial layer 500 may be removed. The photosensitive film pattern 600 and/or the sacrificial layer 500 may be removed by a photoresist strip method.

In an embodiment, the sacrificial layer 500 may be removed through the holes H. Accordingly, an empty space is formed in each region/cavity A surrounded by a light blocker of the light blocking pattern 200 and a protrusion of the first light guide layer 300.

In an embodiment, the sacrificial layer 500 is removed by a photoresist strip method. In an embodiment, the sacrificial layer 500 may be etched and removed.

Referring to FIG. 12, a second light guide layer 400 is formed on the first light guide layer 300. The second light guide layer 400 may be formed by depositing or applying a second material. The second material may be different from the first material used for forming the first light guide layer 300. The second material may include an organic insulating material, such as a fluorocarbon compound including at least one of polyacryl, polyimide, Teflon™, polyepoxy, and benzocyclobutene.

When the second light guide layer 400 is formed, the empty region A may not be filled with the second material through the hole H by given a predetermined size of the hole H and/or predetermined viscosity of the second material. Parts of the second light guide layer 400 may respectively cover the holes H.

Accordingly, a light plate LP is formed.

A display device may be formed by forming a backlight unit by providing a reflection sheet RS, a light source LS, the light plate LP, and a mold frame MF in a bottom chassis BC, and providing a display panel PNL on the backlight unit.

Although example embodiments have been described, those skilled in the art can understand that the embodiments may be variously modified and changed within the scope spirit of the claims.

What is claimed is:

1. A display device, comprising:
a display panel;
a light source configured to supply light;
a substrate overlapping the display panel and configured to receive the light from the light source;
a first light guide layer positioned between the substrate and the display panel, configured to receive the light from the substrate, and comprising base portions and protrusions, the protrusions protruding from the base portions toward the display panel; and
a second light guide layer configured to receive the light from the first light guide layer and configured to provide the light toward the display panel, wherein portions of the second light guide layer overlap the base portions and are positioned between the protrusions.

2. The display device of claim 1, further comprising:
light blockers positioned between the substrate and the protrusions, respectively, and positioned between the base portions.

3. The display device of claim 2,
wherein the light blockers include a first light blocker,
wherein the protrusions include a first protrusion,
wherein the base portions include a first base portion,
wherein the first protrusion includes a first overlapping portion and a first inclined portion,
wherein the first overlapping portion overlaps the first light blocker, is positioned between the first light blocker and the display panel, and is connected through the first inclined portion to the first base portion, and
wherein the first inclined portion is directly connected to each of the first base portion and the first overlapping portion and is oriented at a predetermined acute angle with respect to a surface of the substrate.

4. The display device of claim 3,
wherein the first inclined portion is configured to receive the light from the first base portion and is configured to reflect the light, and
wherein a portion of the second light guide layer directly contacts the first inclined portion, is configured to receive the light from the first inclined portion, and is configured to transmit the light toward the display panel.

5. The display device of claim 3, wherein the first overlapping portion includes a through hole.

6. The display device of claim 3, wherein the first protrusion has a cavity surrounded by the first light blocker, the first inclined portion, and the first overlapping portion.

7. The display device of claim 1, wherein the protrusions are hollow.

8. The display device of claim 1, wherein the first light guide layer includes a first material, and wherein the second light guide layer includes a second material different from the first material.

9. A method of manufacturing a light guide plate, the method comprising:
forming a plurality of light blockers on a substrate, wherein light blockers include a first light blocker;
forming a first light guide layer on the substrate, wherein the first light guide layer comprises base portions and protrusions, wherein the protrusions protrude from the base portions and include a first protrusion, and wherein the first light blocker is positioned between the substrate and the first protrusion and is positioned between two of the base portions; and
forming a second light guide layer on the first light guide layer, wherein portions of the second light guide layers overlap the base portion s and are positioned between the protrusions.

10. The method of claim 9, wherein the forming of the light blockers comprises:
forming a light blocking layer on the substrate;
forming a sacrificial member set on the light blocking layer; and
etching the light blocking layer using the sacrificial member set as a mask.

11. The method of claim 10, wherein the sacrificial member set includes tapered sacrificial members.

12. The method of claim 10, wherein the first light guide layer directly contacts each of the substrate and the sacrificial member set.

13. The method of claim 12, further comprising, before the forming of the second light guide layer:
forming holes at the protrusions; and
removing the sacrificial member set through the holes.

14. The method of claim 13, further comprising:
covering the holes using parts of the second light guide layer.

15. The method of claim 9, wherein the first light guide layer includes a first material, and wherein the second light guide layer includes a second material different from the first material.

16. A light guide plate, comprising:
a substrate;
a plurality of light blockers positioned on the substrate, wherein light blockers include a first light blocker;
a first light guide layer positioned on the substrate, comprising base portions, and comprising protrusions, wherein the protrusions protrude from the base portions and include a first protrusion, and wherein the first light blocker is positioned between the substrate and the first protrusion and is positioned between two of the base portions; and
a second light guide layer positioned on the first light guide layer, wherein portions of the second light guide layers overlap the base portion s and are positioned between the protrusions.

17. The light guide plate of claim 16, wherein the first protrusion comprises:
a first overlapping portion, which overlaps the first light blocker; and
a first inclined portion, which is directly connected to a base portion of the first light guide layer, is directly connected to the first overlapping portion, and is oriented at a predetermined acute angle with respect to a surface of the substrate.

18. The light guide plate of claim 17,
wherein the first protrusion has a cavity surrounded by the first inclined portion,
wherein the cavity has a first cavity portion and a second cavity portion, and
wherein the second cavity portion is positioned between the first cavity portion and the substrate and is wider than the first cavity portion in a direction parallel to the surface of the substrate.

19. The light guide plate of claim 16,
wherein the first protrusion has a through hole and a cavity, and
wherein the through hole is narrower than the cavity, is positioned between the cavity and a part of the second light guide layer, is directly connected to the cavity, and is covered by the part of the second light guide layer.

20. The light guide plate of claim 16, wherein a refractive index of the first light guide layer is unequal to a refractive index of the second light guide layer.
